(19) United States
(12) Patent Application Publication
(10) Pub. No.: US 2021/0261208 A1
(43) Pub. Date: Aug. 26, 2021

(54) A DRIVE MODULE FOR A VEHICLE AND A VEHICLE ASSEMBLED FROM A SET OF MODULES

(71) Applicant: Scania CV AB, Södertälje (SE)

(72) Inventors: André CLAESSON, Tullinge (SE); Robert SJÖDIN, Nyköping (SE); Linus ÄHRLIG, Västerhaninge (SE); Sami TEPPOLA, Nykvarn (SE); Mikko KALLIO, Hölö (SE); Tomas SKEPPSTRÖM, Södertälje (SE); Morgan COLLING, Hölö (SE)

(21) Appl. No.: 17/254,904

(22) PCT Filed: Jun. 18, 2019
(86) PCT No.: PCT/SE2019/050580

§ 371 Date: Dec. 22, 2020

(30) Foreign Application Priority Data
Jul. 4, 2018 (SE) 1850846-5

(51) Int. Cl. B62D 63/02; B60P 1/64; B60P 3/42

(52) U.S. Cl. CPC B62D 63/025; B62D 47/006; B60P 3/42; B60P 1/64

(57) ABSTRACT

The invention relates to a drive module (1) for a vehicle (2), wherein the drive module (1) is adapted to be releasably connected to a functional module (6) for forming an assembled vehicle (2), the drive module (1) including: at least a pair of wheels (8); at least one propulsion unit (10) connected to the pair of wheels (8); at least one energy storage unit (12) for providing the propulsion unit (10) with energy; a control device (16) configured to operate the drive module (1) as an independently driven unit; and at least two interfaces (14) for releasable connection with a functional module (6), each interface (14) being arranged on different sides of the drive module (1). The invention also relates to a vehicle (2) assembled from a set of modules (1, 6).

### CROSS-REFERENCE TO RELATED APPLICATIONS

The present application is a 35 U.S.C. §§ 371 national phase conversion of PCT/SE2019/050580, filed Jun. 18, 2019, the contents of which are incorporated herein by reference which claims priority of Swedish Patent Application No. 18508465-5, filed Jul. 4, 2018, the contents of which are incorporated by reference herein. The PCT International Application was published in the English language.

### TECHNICAL FIELD

The invention relates to a drive module for a vehicle and a vehicle assembled from a set of modules according to the invention.

### BACKGROUND

Vehicles of today are typically manufactured for a specific purpose, e.g. a bus is manufactured for transporting people and a truck is manufactured for transporting goods. Such vehicles are typically manufactured and completely assembled in a factory or they may be partly assembled in a factory and completed at a body manufacturer. Once the vehicle is assembled, the vehicle may be used for the specific purpose. Thus, a bus may be used as a bus and a garbage truck may be used as a garbage truck. Different vehicles are thus needed for different purposes, which may require a large fleet of vehicles and which may be very costly. It may therefore be desired to be able to customize a vehicle depending on different missions.

There are, for example, known solutions where a truck can be rebuilt by changing a concrete mixer to a loading platform. This increases the flexibility and two different functions can be achieved by means of one single vehicle. Also, document US-2016/0129958 A discloses a modular electric vehicle using interchangeable vehicle assembly modules. The user can thereby disassemble and reassemble the vehicle for use in different applications. Disassembling and reassembling such a vehicle would, however, be a very cumbersome and time consuming work. Furthermore, when a failure occurs in one of the known vehicle modules it may be difficult to replace the failing module, which may result in that the vehicle being unusable for a considerable period of time. It may also be cumbersome to transport the replacement module to the site of the vehicle with the failing module.

### SUMMARY

Despite known solutions in the art, it may be desired to develop a modular vehicle which may be assembled and disassembled easily and in a short period of time.

An object of the invention is therefore to achieve a modular vehicle, which can be assembled and disassembled in a more time efficient and easier way.

Another object of the invention is to achieve a drive module for a modular vehicle, which enables quicker and easier assembly and disassembly of the vehicle.

Another object of the invention is to achieve a vehicle module, which can be easily replaced in case of failure.

The herein mentioned objects are achieved with the above-mentioned drive module according to the invention.

The drive module is adapted to be releasably connected to a functional module for forming an assembled vehicle. The drive module comprises at least a pair of wheels, at least one propulsion unit connected to the pair of wheels, at least one energy storage unit for providing the propulsion unit with energy, and a control device configured to operate the drive module as an independently driven unit. The drive module comprises at least two interfaces for releasable connection with a functional module, each interface being arranged on a different side of the drive module.

By having a drive module configured to be operated as an independently driven unit by means of the control device, a modular vehicle may quickly and easily be assembled and disassembled, without manual work. Thus, the flexibility to assemble different types of vehicles intended for different missions will be possible. Instead of having a fleet of different types of vehicles, which may be used for different purposes, at least one drive module according to the invention may be used together with different functional modules. The functional modules may be designed for specific purposes. Therefore, by combining a drive module with a suitable functional module, it is possible to customize a vehicle depending on different missions it is to perform. A functional module may be prepared to perform a specific function and the drive module, as an independently driven unit may connect with the functional module to achieve an assembled vehicle customized for a specified mission. By having at least two interfaces for connection with a functional module on at least two different sides of the drive module, the drive module can be connected to a functional module in various ways and the flexibility to select a way is increased. One of the at least two interfaces on the drive module can be connected to the functional module. The other interface or interfaces may be connected to something else, such as another drive module. The other interface or interfaces may alternatively not be connected to another module. As a result, a large fleet of different vehicles can be achieved by quickly and easily connecting/disconnecting at least one drive module with different functional modules.

The above-mentioned objects are also achieved by a vehicle assembled from a set of modules according to the invention.

A vehicle assembled from a set of modules comprises at least one functional module, wherein the functional module is configured for accommodating or supporting a load. The vehicle further comprises at least one drive module as disclosed herein, wherein the drive module is releasably connected with the functional module.

Such a vehicle assembled from a set of modules may be configured to be operated as an independently driven vehicle by means of the drive module. The assembly and disassembly of the vehicle is facilitated and more time efficient by means of the drive module being operated as an independently driven unit. Instead of having a fleet of different types of vehicles, which may be used for different purposes, different types of vehicles intended for different missions may be assembled from a set of the modules. The set of modules may comprise several different functional modules, which may be designed for specific purposes. Therefore, by combining at least one drive module with a suitable functional module, it is possible to customize a vehicle depending on different missions. Since the assembly is easier and quicker, assembly and disassembly of a vehicle may be performed more frequently. In this way, a plurality of different vehicle types may be assembled from the set of modules during a day. For example, during daytime, at least one drive module may be connected with a functional module to assemble a vehicle to function as a bus and whereas during the night, when there is no need for a bus, the same drive module may be used to assemble a vehicle to function as a garbage truck. Because the same module can be used in various different types of vehicles, the utilization of the modules can be optimized. Furthermore, in the event of errors, damages or breakage of a drive module, the failing drive module can easily be disconnected and removed from the vehicle and can be repaired/fixed. The failing drive module can quickly be replaced with a replacement drive module and the reassembled vehicle can then continue its operation. Instead of having to use another vehicle to transport the replacement drive module to the site of the vehicle, the replacement drive module may transport itself, as an independently driven unit, to the site of a vehicle with the failing module. The vehicle off road (VOR) time will thereby be reduced and the utilization of the vehicle will increase.

Additional objectives, advantages and novel features of the invention will be apparent to one skilled in the art from the following details, and through exercising the invention. While the invention is described below, it should be apparent that the invention may not be limited to the specifically described details. One skilled in the art, having access to the teachings herein, will recognize additional applications, modifications and incorporations in other areas, which are within the scope of the invention.

### BRIEF DESCRIPTION OF THE DRAWINGS

Below is a description of, as examples, preferred embodiments with reference to the enclosed drawings, in which:

FIG. 1a schematically illustrates a side view of a drive module according to an embodiment;

FIG. 1b schematically illustrates a front view of a drive module according to an embodiment;

FIG. 1c schematically illustrates a view from above of a drive module according to an embodiment;

FIG. 2 schematically illustrates a drive module in a section view along line I-I in FIG. 1c;

FIG. 3a schematically illustrates a side view of a drive module and a functional module according to an embodiment;

FIG. 3b schematically illustrates an assembled vehicle according to an embodiment;

FIG. 4a schematically illustrates a side view of two drive modules and a functional module according to an embodiment;

FIG. 4b schematically illustrates an assembled vehicle according to an embodiment; and

FIGS. 5a-5d schematically illustrates assembled vehicles according to different embodiments.

### DETAILED DESCRIPTION

To be able to meet customers' different vehicle needs in a flexible and cost efficient way, a drive module and a modularized vehicle have been developed. A modularized vehicle according to the present disclosure may be assembled at the customer's premises and the customer may thus buy a set of modules from a manufacturer. The drive module and the modularized vehicle as described herein may be applicable on all sorts of land vehicles, such as road vehicles and off-road vehicles. Thus, the disclosure may relate to heavy vehicles, such as buses, trucks etc. Specifically, the present disclosure may relate to vehicles for use on public roads.

According to an aspect of the present disclosure a drive module for a vehicle is provided, wherein the drive module is adapted to be releasably connected to a functional module for forming an assembled vehicle. The drive module comprises: at least a pair of wheels; at least one propulsion unit connected to the pair of wheels; at least one energy storage unit for providing the propulsion unit with energy; a control device configured to operate the drive module as an independently driven unit; and at least two interfaces for connection with a functional module, each interface being arranged on different sides of the drive module.

Since the drive module may be configured to be operated as an independently driven unit by means of the control device, the drive module may be connected with, or disconnected from, the functional module without manual work. The drive module thereby enables a time efficient and facilitated assembly and disassembly of a modular vehicle. Thus, the flexibility to assemble different types of vehicles intended for different missions will be possible. Instead of having a fleet of different types of vehicles, which may be used for different purposes, at least one drive module according to the disclosure may be used together with different functional modules. The functional modules may be designed for specific purposes. Therefore, by combining a drive module with a suitable functional module, it may be possible to customize a vehicle depending on different missions. A functional module may be prepared for a specific mission and the drive module may, as an independently driven unit, drive and transport itself to that functional module. As a result, a large fleet of different vehicles may be achieved by easily, and in a short period of time, connecting at least one drive module with different functional modules. Thus, such a large fleet of different vehicles may be handled very time efficient. By having at least two interfaces for connection with a functional module on at least two different sides of the drive module, the drive module can be connected to a functional module in various ways and the flexibility is increased.

The interfaces of the drive module may be releasably connectable to a corresponding interface on a second drive module and/or a functional module. By having at least two interfaces, it is possible to arrange and connect the drive module in at least two different ways in relation to the second drive module and/or the functional module.

Also, the drive module comprising at least two interfaces enables simultaneous connection with at least two other modules, such as two functional modules. One functional module may be connected to one of the interfaces of the drive module and another functional module may be connected to the other interface of the drive module. Thus, one of the at least two interfaces on the drive module can be connected to the functional module. However, one or more of the other interfaces of the drive module may alternatively not be connected to another module, when one of the interfaces of the drive module is connected to a module, such as a function module.

A failing drive module may be easily replaced by operating the failing drive module as an independently driven unit to disconnect and remove the failing drive module from the functional module. When the drive module has been disconnected, another drive module may be connected to the functional module. The replacement drive module may easily be driven and transported by itself, as an independently driven unit, to the site of a vehicle with the failing module.

According to an example, the drive module has only one pair of wheels. A drive module with only one pair of wheels may have good maneuvring abilities. The drive module may turn about a vertical axis that extends between the two wheels. The design of the drive module may also be very compact when only two wheels are arranged at the drive module. With the drive module having only two wheels, typically two drive modules are needed to assemble a vehicle, depending on whether the functional module comprises wheels or not.

The pair of wheels may be arranged at the drive module, such that a center axis of each wheel coincides with the other. Each wheel has a center axis and may be arranged at the drive module so that each wheel may rotate about its center axis. The center axis of each wheel may thus be referred to as the rotational axis of each wheel. The center axis of the wheels coinciding means that the center axis of the wheels are aligned. By having the center axis of each wheel coinciding with each other the drive module has good maneuvring abilities. Also, the drive module may be able to make a pivoting movement about the coinciding center axis of the two wheels. Thus, the drive module may be configured to pivot about the common center axis of the two wheels. This pivoting movement of the drive module may be useful when connecting and disconnecting the drive module with other modules. The control device configured to operate the drive module as an independently driven unit may be configured to control the pivoting movement of the drive module.

The propulsion unit of the drive module may be an electric machine, connected to the wheels. The pair of wheels of the drive module may thus be referred to as drive wheels. In one example, the drive module comprises two electrical machines, one connected to each wheel. The electric machines may be arranged in the rim of the wheels. The wheels of the drive module may thus be driven independently of each other. The electric machines may also work as generators and generate electric energy when braking the wheels. The drive module may also comprise a steering system connected to the wheels. In this way, the drive module is steerable. The drive module may also comprise a brake system for braking the wheels. The brake system may comprise a wheel brake for each wheel of the drive module. Redundancy is achieved in that the drive module can be steered by means of the electrical machines and/or the wheel brakes in the event that the steering system malfunctions.

The drive module may comprise a body and the pair of wheels may be arranged on two opposite sides of the body of the drive module. The body may have a first and a second side, which are facing in opposite directions. The body may have a third and a fourth side, which are facing in opposite directions, wherein the third side and the fourth side extend perpendicularly to the first and the second sides. The body may also have a fifth and a sixth side, which are facing in opposite directions. The fifth and the sixth sides may extend perpendicularly to the first and the second sides and the third and fourth sides. The first and the second sides may be referred to as side surfaces. The third and the fourth sides may be referred to as front and rear surfaces respectively. The fifth side may be referred to as a top surface and the sixth side may be referred to as a bottom surface. The sides may have a shape that are flat or curved and may be shaped with indentations and protrusions. Instead of the perpendicularity of the extension of the sides described above, the sides may extend at any angle in relation to each other.

According to an example, the interfaces on the drive module are identical. According to an example, the drive module comprises an interface for connection with the functional module on a front surface of the drive module and on a rear surface of the drive module. The same drive module can thereby be connected to a front section of a functional module and to a rear section of a functional module, without having to turn the drive module around. Additionally or alternatively, the drive module may comprise an interface on a top surface or a bottom surface of the drive module. The interfaces of the drive module may also be configured for connection with another drive module. Thus, the interfaces of the drive module may be adapted for connection with a functional module and another drive module. By using identical interfaces which can be used for connection with another drive module as well as a functional module, the flexibility of the drive module increases and the assembly of a vehicle is facilitated.

According to an example, the control device of the drive module is adapted to receive instructions to configure the drive module based on a function to be performed by the assembled vehicle. The drive module may thus be adapted to be dynamically configured. The drive module being adapted to be dynamically configured means that the configuration of the drive module is non-static and the drive module can thus be reconfigured depending on various factors. The drive module may thus be adapted to be configured in real time. The control device of the drive module may be adapted to receive, from an off-board system, instructions to configure the drive module in a certain way, based on a function to be performed by the assembled vehicle. The drive module may be adapted to receive configuration instructions before or when it has been connected with a functional module and a vehicle thereby is assembled. The drive module may also be adapted to receive configuration instructions partly before or partly after it has been connected with a functional module. Thus, the drive module may be adapted to be configured when it is connected to a functional module and thus forms a part of an assembled vehicle. The off-board system may for example determine that certain suspension characteristics, certain brake settings and/or a certain steering ratio are required for the function to be performed by the assembled vehicle. Different configurations of the drive module may thus be required when the drive module forms part of a vehicle performing the function of transporting people, transporting goods, shoveling snow etc. The drive module may also be adapted to be dynamically configured based on the surroundings in which the vehicle will perform its function. Thus, different suspension characteristics may for example be required if the vehicle will be operated in a rough terrain compared to if the vehicle will be operated on a highway. The off-board system may thus transmit instructions to the control device of the drive module, such that the control device configures the drive module accordingly.

According to an example, the control device is adapted to receive, from an off-board system or remote operator, a configuration for the at least one drive module in the form of instructions to configure the at least one drive module, wherein the configuration is based on a function to be performed by the assembled vehicle, and further adapted to configure one or more characteristics of the at least one drive module according to the received instructions.

The configuration instructions from the off-board system may also be based on the selected functional module connected with the drive module. The off-board system may be referred to as a control center and may be geographically at a distance from the modules. The drive module may thus be adapted to receive configuration instructions wirelessly. The off-board system may be adapted to receive information about missions or functions to be performed and based on this mission/function initiate the assembly of a vehicle. The off-board system may be implemented as a separate entity or distributed in two or more physical entities. The off-board system may comprise one or more computers.

According to an example, the control device of the drive module is adapted to store at least one configuration of the drive module, which stored configuration is based on a function to be performed by the assembled vehicle.

There may be configurations of the drive module, which are more common than other configurations. Such configurations may be stored in the control device of the drive module or in a separate memory connected to the control device. Thus, the control device of the drive module may be configured to store a plurality of different configurations for the at least one drive module, where each configuration is associated with a certain type of assembled vehicle and/or a certain function to be performed by the assembled vehicle. In this way, when the control device knows which function module to connect to the drive module, and thus which type of vehicle the drive module will be part of, and/or when the control device knows which function the assembled vehicle should perform, the stored configuration of the drive module associated with the assembled vehicle and/or the function to be performed is used to configure the at least one drive module. For example, if the at least one drive module is part of a garbage truck, a specific stored configuration associated with such type of vehicle may easily be brought from the control device or the memory connected to the control device.

According to an example, the configuration is defined by configuration parameters associated with characteristics of the drive module including at least one of: suspension, steering, braking and power outtake.

Depending on the function to be performed by the assembled vehicle, the characteristics of the drive module may be configured based on the road and terrain characteristics and the characteristics of the assembled vehicle.

According to an example, the drive module comprises at least one sensor for detecting and registering objects in the surrounding area around the drive module. The at least one sensor may be a proximity sensor for detecting and registering the distance to objects, such as vehicles, pedestrians and buildings. The control device of the drive module may be arranged in communication with the at least one sensor. Based on information from the at least one sensor, the drive module may be operated to maintain a safe distance from the surrounding objects so that accidents are avoided.

According to an example, the drive module is configured to be autonomously operated. That means that the control device of the drive module is configured to receive commands and instructions from the off-board system and to execute these commands/instructions. The autonomously operated drive module may thus be said to be self-operated based on received commands and instructions from the off-board system. The autonomously operated drive module may thus be self-operated without an on-board or off-board driver. The control device may be adapted to convert the commands to control signals for controlling the systems and components of the drive module and thereby may, for example control the steering and the propulsion of the drive module. In this way, the drive module is self-driven based on the received commands and instructions. The control device may operate the drive module autonomously also based on data from the at least one sensor, taking situations that may happen during transportation into account.

According to an example, the control device is configured to receive commands from the off-board system to autonomously connect the drive module with a functional module. In this way, the drive module is adapted to autonomously perform the connection with the functional module. The connection with a functional module may thereby be performed without the need for manual work. Assembly of a vehicle may thereby be performed in an easier and more time efficient way.

According to an example, the control device of the drive module is configured to control the drive module through control signals received from a remotely located operator. The operator may be geographically oriented close to, far away from or at any distance from the drive module. The drive module may thus be remote-controlled, based on the control signals. Remotely controlling the drive module may be specifically suitable when the drive module should be moved a short distance. Then, an operator may, wireless or conductively by wire, remotely control the drive module.

According to an example, the drive module is associated with a registration number or another identifying indicator. For example, the registration number of the drive module may constitute the registration number of the assembled vehicle. The drive module may also have a vehicle identification number (VIN). Each drive module may include a registration number. In the event that two or more drive modules are used in an assembled vehicle, only one registration number should be shown. The at least one drive module may thus receive instructions to either show or not show the registration number. The registration number may be presented on a digital screen on the drive module. In the event that the drive module showing the registration number malfunctions, the registration number may be presented by another drive module of the assembled vehicle or the registration number may be presented by a new drive module replacing the malfunctioning drive module. Alternatively, the registration number may be displayed on a display of the functional module.

According to an example, the control device of the drive module is configured to communicate with a second control device of the functional module. The functional module may thus comprise a control device, which is referred to as a second control device. The control device in the functional module will hereinafter be referred to as a second control device. The control device of the drive module may also be configured to communicate with another drive module which is a part of the same assembled vehicle. The communication between the modules may be wireless or conductively by wire. The wireless communication may be directly between the modules or via the off-board system. The control device of the drive module may be configured to communicate with the second control device of the functional module. In case of a wireless communication between the control devices of the modules, each module may include a transmitter and a receiver for the wireless communication. In case of a conductive communication between the control devices of the modules by wire, the functional module may comprise a wire, which connects the interfaces of the functional module. When the two drive modules are connected to the interfaces of the functional module, the control devices of the drive modules may communicate with each other and with the control device of the functional module via the wire in the functional module.

According to an example, the control device is configured to receive, from the second control device of the functional module, at least one configuration for the drive module, wherein the at least one configuration is stored in the second control device of the functional module and is based on a function to be performed by the assembled vehicle.

There may be configurations of the drive module, which are more common than other configurations. Such configurations may be stored in the second control device or in a separate memory connected to the second control device. If the drive module and/or the functional module receives information that the drive module and the function module should be connected, the configuration based on the function to be performed by the assembled vehicle may easily be brought from the second control device or the memory in the functional module. When the drive module and the functional module are connected, the control device of the drive module receives the stored configuration from the second control device of the functional module, and the drive module is thereafter configured based on a function to be performed by the assembled vehicle.

According to an example, the at least two interfaces are physical interfaces, arranged to physically connect the drive module with the functional module and/or a second drive module. The interfaces of the drive module may be releasably connectable to a corresponding interface on the functional module. The physical interfaces may be arranged to transfer load and torque. Such physical interfaces may be configured in different ways, and may for example comprise coupling units adapted to engage, quick couplings, hooks, cooperating protrusions and recesses or similar. It is to be understood that the configuration of the physical interfaces are examples, and not part of the disclosure hereof per se. The drive module may be adapted to push or pull the functional module depending on the driving direction of the assembled vehicle.

According to an example, the at least two interfaces are electric interfaces, arranged for transferring electric energy and/or transmitting electric signals between the drive module and the functional module and/or a second drive module. The electrical interface may be a wireless interface or a conductive interface. By connecting the drive module and the functional module electrically, the modules can transfer energy between each other and also share information. The drive module may, for example, control parts of the functional module, such as opening and closing of doors, heating and cooling. According to an example, the at least two interfaces are combinations of physical and electrical interfaces for connecting the drive module with a functional module.

According to an example, the drive module comprises a separate closed cooling system. The separate closed cooling system may be arranged for cooling the at least one propulsion unit and the at least one energy storage unit. Provided with a separate closed cooling system the drive module may be operated as an independently driven unit, without any need of an external cooling arrangement. Thus, the drive module does not have to share cooling system with any of the other modules of the assembled vehicle. The separate closed cooling system may be based on a liquid coolant or based on a forced flow of cooling air.

According to an example, the drive module is adapted to communicate with a traffic system. The control device of the drive module may be adapted to communicate with a traffic system. The communication between the control device of the drive module and the traffic system may be performed via the off-board system. However, the communication between the control device of the drive module and the traffic system may alternatively, or in combination with the off-board system, be performed via sensors arranged at the drive module or via receivers arranged on the drive module, which receive signals wirelessly from transmitters arranged in the traffic system. The control device of the drive module may thereby be able to determine the status of traffic lights, determine if an accident has occurred and based on that determine a new route for the drive module/vehicle etc. The control device of the drive module may be adapted to communicate directly with such a traffic system or it may be adapted to communicate with such a traffic system via the off-board system.

The present disclosure also relates to a vehicle assembled from a set of modules, the vehicle comprising at least one functional module; wherein the functional module is configured for accommodating or supporting a load, the vehicle further comprising at least one drive module as disclosed herein, which drive module is releasably connected to the functional module.

Such a vehicle assembled from a set of modules may be configured to be operated as an independently driven vehicle by means of the drive module. Instead of assembling and disassembling a set of modules manually, the assembly and disassembly of the independently driven vehicle may thereby be facilitated and more time efficient. Also, by means of an autonomously operated drive module, assembly and disassembly of the vehicle is facilitated and more time efficient. Instead of having a fleet of different types of vehicles, which may be used for different purposes, different types of vehicles intended for different missions may be assembled. The set of modules may comprise several different functional modules, which may be designed for specific purposes. The set of modules may comprise a plurality of drive modules. The different drive modules may be identical or the drive modules may for example have different types/sizes of wheels. Therefore, by combining a drive module with a suitable functional module, it may be possible to customize a vehicle depending on its different missions.

A functional module cannot move on its own but needs to be connected to at least one drive module to be able to move and for the module assembly to thereby function as an assembled vehicle. The functional module may comprise an energy storage unit.

The functional module may comprise at least one interface for the purpose of connecting with a drive module. The second control device of the functional module is configured to communicate with the herein mentioned off-board system. The second control device is also configured to communicate with the control device of the drive module.

According to an example, the assembled vehicle comprises two drive modules. Each drive module may then comprise one pair of wheels. By selecting the at least one functional module and two drive modules based on a function to be performed, a customized vehicle may be assembled, which is customized for the function to be performed. Also, an assembled vehicle may be achieved, which is adapted to the surroundings and the operating conditions of the vehicle. An assembled vehicle provided with two drive modules may have more power and may support larger and heavier vehicles than a vehicle provided with only one drive module. If one of the drive modules were to lose power, the other drive module may take over and drive the vehicle.

According to an example, one of the drive modules is arranged to operate as a master and the other drive module is arranged to operate as a slave. The control device of one of the drive modules may be configured to operate the associated drive module as the master. The control device of the other drive module may be configured to operate the associated drive module as the slave. The master will decide how to operate both of the drive modules and thus how to operate the assembled vehicle. In addition, any further module, such as the functional module being connected to the drive module(s) and which comprises a control device, may become slave in the assembled vehicle. Each drive module is associated with a registration number but only one registration number should be shown on an assembled vehicle. In the event that the assembled vehicle comprises two drive modules, the first control device may appoint one drive module to be master and the other to be slave. Typically, the master will be commanded to show its registration number and the slave will not show its registration number. The first control device may thus transmit instructions regarding the registration number to the second control device of the at least one drive module.

The vehicle comprises at least one drive module, which may be configured to be autonomously operated. Thus, the assembled vehicle may be configured to be autonomously operated. The assembled vehicle being autonomously operated means that the control device of the drive module may be configured to receive commands and instructions from a control center or an off-board system and to execute these commands/instructions. The autonomously operated vehicle is thus operated based on the received commands and instructions from the control center or the off-board system. The control device may control the systems and components of the drive module based on the received commands and instructions and thereby may, for example control the steering and the propulsion of the assembled vehicle. In this way, the assembled vehicle can drive itself based on the received commands and instructions. The control device of the drive module may control the assembled vehicle to be autonomously driven or operated based also on data from the at least one sensor, taking situations that may happen during transportation into account.

According to an example, the vehicle is a truck and the functional module is configured for transporting goods. The functional module configured for transporting goods may be connected to a drive module. Together they form a truck for transporting goods. The functional module may comprise a space, such as a platform or defined volume for accommodating or supporting the goods.

According to an example, the vehicle is a fork lift and the functional module is a fork lift apparatus. The fork lift apparatus may be provided with forks for lifting and moving e.g. pallets. The fork lift apparatus may be provided with an interface connectable to at least one of the interfaces of the drive module. Together, the fork lift apparatus and the drive module form a fork lift.

According to an example, the vehicle is a passenger bus and the functional module is configured with a passenger compartment. The passenger compartment is adapted to accommodate passengers. The functional module may be assembled together with two drive modules. A bus assembled from modules is very flexible. When there is a malfunction in one of the drive modules, another drive module may be transported by its own motion to the bus. By replacing the malfunctioning drive module, the bus may quickly be in operation again and can thereby fulfil its mission without discomfort for the passengers.

According to an example, the vehicle is a container lift vehicle and the functional module is a container lift. A container lift vehicle provided with a container lift is arranged for lifting and moving containers. The container lift is provided with an interface which may be connected to one of the interfaces of the drive module. The drive module may communicate with, and/or control, the container lift via the interface. Thus, the container lift is adapted to receive signals from the drive module to operate the container lift. A container can be lifted and moved by two container lift vehicles each provided with a container lift. The drive modules with container lifts may grip the container from opposite sides of the container. The container may be lifted simultaneously by the container lifts, which are arranged on the drive modules. Thereafter the container lift vehicles may together move the container.

According to an example, the vehicle is a tractor vehicle and the functional module is a turntable, which turntable may be connectable to a trailer. The turntable may be arranged on a drive module. The turntable and the drive module together form a tractor vehicle for transporting other vehicles, such as trailers, which may be provided with a kingpin for connecting with the turntable. The turntable is thus arranged for connecting a trailer to the drive module. The turntable is provided with an interface. The interface of the turntable may be connected to one of the interfaces of the drive module. The drive module may communicate with the turntable via the interface. The drive module may control the turntable to lock and release the kingpin arranged on the trailer. The turntable may be arranged on a distance element arranged on a drive module or between two drive modules. The distance element may be provided with at least two interfaces if arranged on the drive module. One of the interfaces is connected to the drive module and the other interface is connected to the turntable. When the distance element is arranged between two drive modules, the distance element may be provided with at least three interfaces. With such a distance element arranged between two drive modules, at least one of the drive modules communicates with the turntable through the interfaces of one of the drive modules, of the distance element and of the turntable.

According to an example, the vehicle is an excavator and the functional module is a bucket. The bucket is thus connected to the drive module. The bucket and the drive module together form an excavator. The bucket may be arranged for excavating for example soil, snow or similar. The bucket is provided with an interface. The interface of the bucket is connectable to at least one of the interfaces of the drive module. The drive module is adapted to communicate with the bucket via the interface. The drive module controls the bucket for excavating soil, snow or similar.

According to an aspect of the present disclosure, a drive module for a vehicle is adapted to be releasably connected to a functional module for forming an assembled vehicle. The drive module comprises: at least a pair of wheels; at least one propulsion unit connected to the pair of wheels; at least one energy storage unit for providing the propulsion unit with energy; at least two interfaces for releasable connection with a functional module; and a control device configured to operate the drive module as an independently driven unit. The control device of the drive module is adapted to receive instructions to configure the drive module based on a function to be performed by the assembled vehicle. It is to be understood that other embodiments of the drive module as disclosed herein can be combined with this embodiment.

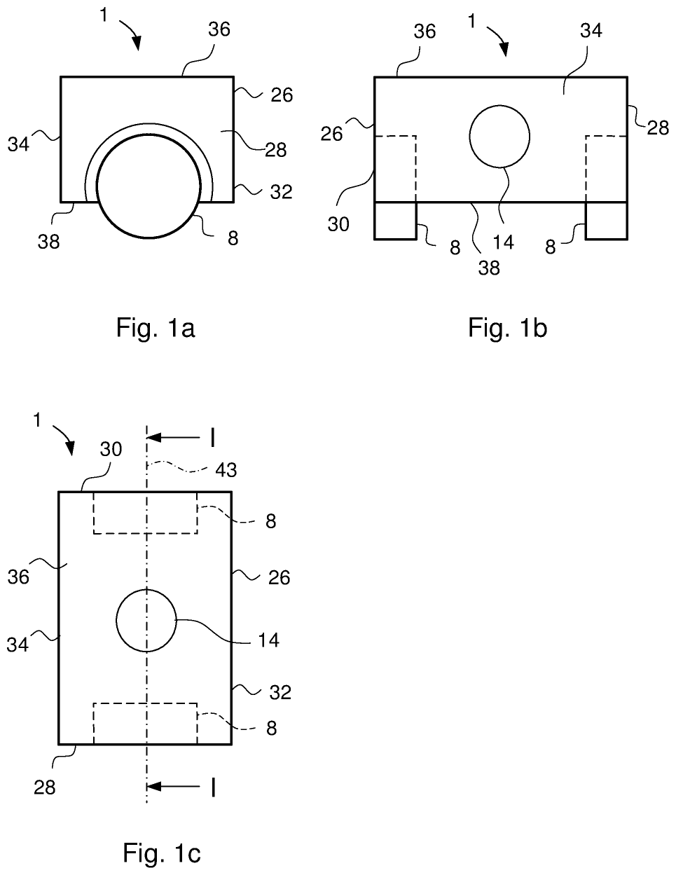

FIGS. 1a-1c schematically show a drive module 1 respectively in a side view, a front view and in a view from above, according to an embodiment. The drive module 1 may comprise a body 26 provided with a pair of wheels 8 arranged on two opposite sides of the drive module 1. The body 26 may have a first and a second side 28, 30, which face in opposite directions. The body 26 may have a third and a fourth side 32, 34, which also face in opposite directions, wherein the third side 32 and the fourth side 34 may extend perpendicular to the first and the second sides 28, 30. The body 26 may also have a fifth and a sixth side 36, 38, which face in opposite directions. The fifth and the sixth sides 36, 38 may extend perpendicularly to the first and the second sides 28, 30 and to the third and fourth sides 32, 34. The first and the second sides 28, 30 may be referred to as side surfaces. The third and the fourth sides 32, 34 may be referred to as front and rear surfaces. The fifth side 36 may be referred to as a top surface and the sixth side 38 may be referred to as a bottom surface. The sides 28, 30, 32, 34, 36, 38 may each have a shape that is flat or curved and may be shaped with indentations and protrusions. Instead of the perpendicularity of the extension of the sides 28, 30, 32, 34, 36, 38 described above, the sides 28, 30, 32, 34, 36, 38 may extend at any angle in relation to each other.

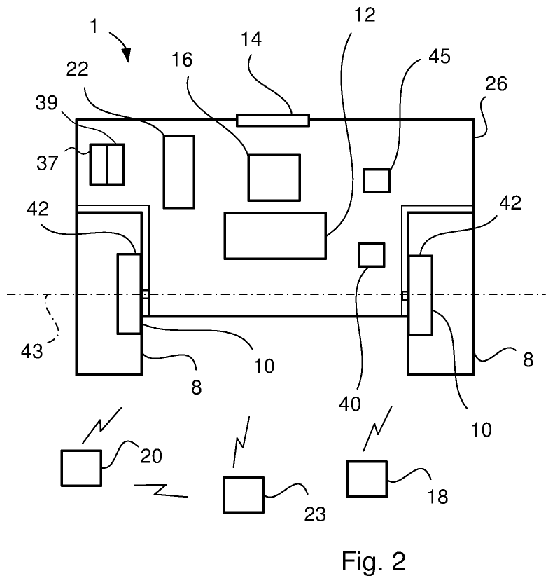

The drive module 1 may comprise a pair of wheels 8. The wheels 8 may be arranged at the first and second sides 28, 30 of the drive module 1. One wheel 8 may be arranged at the first side 28 and the other wheel 8 may be arranged at the second side 30. A steering unit 40 (FIG. 2) may be connected to the wheels 8. The steering unit 40 may make the drive module 1 steerable. The pair of wheels 8 may be so arranged at the drive module 1 that a center axis 43 of each wheel 8 coincides with each other as disclosed in FIG. 1c. Each wheel 8 has a center axis 43 and may be arranged at the drive module 1 so that each wheel 8 may rotate about its center axis 43. When the center axis 43 of each wheel 8 coincides with the axis of the other wheel, the drive module 1 has good maneuvring abilities. Also, the drive module 1 may be configured to enable a pivoting movement about the coinciding center axis 43 of the two wheels 1. This pivoting movement of the drive module 1 may be useful when connecting and disconnecting the drive module 1 with other modules 6. The control device 16 configured to operate the drive module 1 as an independently driven unit may control the pivoting movement of the drive module 1.

The drive module 1 may comprise at least two interfaces 14 for transferring electric energy and/or transmitting electric signals, and for physically connection, which will be described in more detail below in relation to FIG. 2.

FIG. 2 schematically illustrates a drive module 1 in a section view along line I-I in FIG. 1c. The drive module 1 may comprise at least one propulsion unit 10 connected to the pair of wheels 8. The propulsion unit 10 may be an electric machine connected to the wheels 8. According to the embodiment in FIG. 2, two electric machines may be arranged as propulsion units 10 in the drive module 1. One electric machine 10 may be connected to one wheel 8 and the other electric machine 10 may be connected to the other wheel 8. The electric machines 10 may be arranged in the rim 42 of the wheels 8. The wheels 8 may thereby be driven independently of each other. The electric machines 10 may also work as generators and generate electric energy when braking the wheels 8. Instead of electric machines 10 as a propulsion unit 10, the at least one propulsion unit 10 may be an internal combustion engine, such as an Otto engine or a diesel engine connected to the wheels 8.

The drive module 1 may comprise at least one energy storage unit 12 for providing the propulsion unit 10 with energy. In the case where the propulsion unit 10 is an electric engine, the energy storage unit 12 may be an electric battery. The electric battery may be recharged with electric energy. Alternatively, when the electric battery is discharged, the electric battery may be replaced by another charged electric battery. In the case where the propulsion unit 10 is an internal combustion engine, the energy storage unit 12 may be a fuel tank with fuel suitable for the internal combustion engine.

The drive module 1 may comprise a separate closed cooling system 22 for cooling the at least one propulsion unit 10 and the at least one energy storage unit 12. When the drive module is provided with a separate closed cooling system 22, the drive module 1 may be operated as an independently driven unit, without any need of an external cooling arrangement. Also, the drive module 1 does not have to be connected to a cooling system of a functional module. The separate closed cooling system 22 may be based on a liquid coolant or based on a forced flow of cooling air.

The drive module 1 may include a control device 16 configured to operate the drive module 1 as an independently driven unit. The drive module 1 may transport itself without any external driven unit such as a towing vehicle. The drive module 1 may transport itself by means of the at least one propulsion unit 10. The drive module 1 may be configured to be autonomously operated. Thus, the control device 16 may be configured to control the operation of the drive module 16. The control device 16 may be configured to transmit control signals to the various systems and components of the drive module 1 for controlling for example the steering and the propulsion of the drive module 1. The control device 16 may be adapted to operate the drive module 1 autonomously based on received commands. The control device 16 may thus be adapted to receive commands from a remotely located off-board system 20 and to convert the commands into control signals for controlling the various systems and components of the drive module 1. The control device 16 may also be configured to receive data about the surroundings from at least one sensor 45 and, based on this data, control the drive module 1. The control device 16 may be implemented as a separate entity or distributed in two or more physical entities. The control device 16 may comprise one or more computers. The control device 16 may thus be implemented or realized by the control device 16 comprising a processor and a memory.

The drive module 1 may be adapted to be configured based on a function to be performed by the drive module 1 itself or as an assembled vehicle 2. The drive module 1 may itself thus constitute a vehicle. The control device 16 of the drive module 1 may be adapted to receive, from an off-board system 20, instructions to configure the drive module 1 in a certain way, based on a function to be performed by the drive module 1 itself or by the assembled vehicle 2. Thus, the drive module 1 may be adapted to be configured when it is connected to a functional module 6 and thus forms a part of an assembled vehicle 2. The drive module 1 may also be adapted to be dynamically configured based on the surroundings in which the vehicle 2 will perform its function. Thus, different suspension characteristics may for example be required if the vehicle 2 will be operated in a rough terrain compared to if the vehicle 2 will be operated on a highway. The drive module 1 being adapted to be a dynamically configured which means that the configuration of the drive module 1 is non-static and the drive module 1 can thus be reconfigured depending on various factors. The control device 16 of the drive module 1 may be adapted to receive, from an off-board system 20, instructions to configure the drive module 1 in a certain way, based on a function to be performed by the assembled vehicle 2. The drive module 1 may be adapted to receive configuration instructions before or when it has been connected with a functional module 6 and a vehicle 2 thereby is assembled. The drive module 1 may also be adapted to receive configuration instructions partly before or partly after it has been connected with a functional module 6. Thus, the drive module 1 may be adapted to be configured when it is connected to a functional module 6 and thus forms a part of an assembled vehicle 2. The off-board system 20 may for example determine that certain suspension characteristics, certain brake settings and/or a certain steering ratio are required for the function to be performed by the assembled vehicle 2. Different configurations of the drive module 1 may thus be required when the drive module 1 forms part of a vehicle 2 performing the function of transporting people, transporting goods, shovelling snow etc. The drive module 1 may also be adapted to be dynamically configured based on the surroundings in which the vehicle 2 will perform its function. Thus, different suspension characteristics may for example be required if the vehicle 2 will be operated in a rough terrain compared to if the vehicle 2 will be operated on a highway. The off-board system 20 may thus transmit instructions to the control device 16 of the drive module 1, such that the control device configures the drive module accordingly. The configuration instructions from the off-board system 20 may also be based on the selected functional module 6 connected with the drive module 1.

The control device 16 of the drive module 1 may alternatively be configured to control the drive module 1 through control signals received from a remotely located operator 18. The operator 18 may be geographically oriented close to, far away from or at any distance from the drive module 1. The drive module 1 may thus be remote-controlled based on the control signals. Thus, when the drive module 1 should be moved a short distance, an operator 18 may wireless or conductively by wire remotely control the drive module 1. In case of a wireless communication between the control device 16 of the drive module 1 and the surrounding, such as other modules, the drive module 1 may comprise a transmitter 37 and a receiver 39 for the wireless communication. However, the control device 16 may alternatively comprise a built in transmitter and receiver. The drive module 1 will not be provided with a cabin for the operator 8.

The drive module 1 may be adapted to communicate with a traffic system 23. The control device 16 of the drive module 1 may be adapted to communicate with a traffic system 23. The communication between the control device 16 of the drive module 1 and the traffic system 23 may be performed via the off-board system 20. However, the communication between the control device 16 of the drive module 1 and the traffic system 23 may alternatively, or in combination with the off-board system 20, be performed via sensors 45 arranged at the drive module 1 or via receivers arranged on the drive module 1, which receives signals wireless from transmitters arranged in the traffic system 23. The control device 16 of the drive module 1 may thereby be able to determine the status of traffic lights, notice accidents, etc. The control device 16 of the drive module 1 may be adapted to communicate directly with such a traffic system 23 or it may be adapted to communicate with such a traffic system 23 via the off-board system 20. In FIG. 2, the different components may be connected to each other by means of wires.

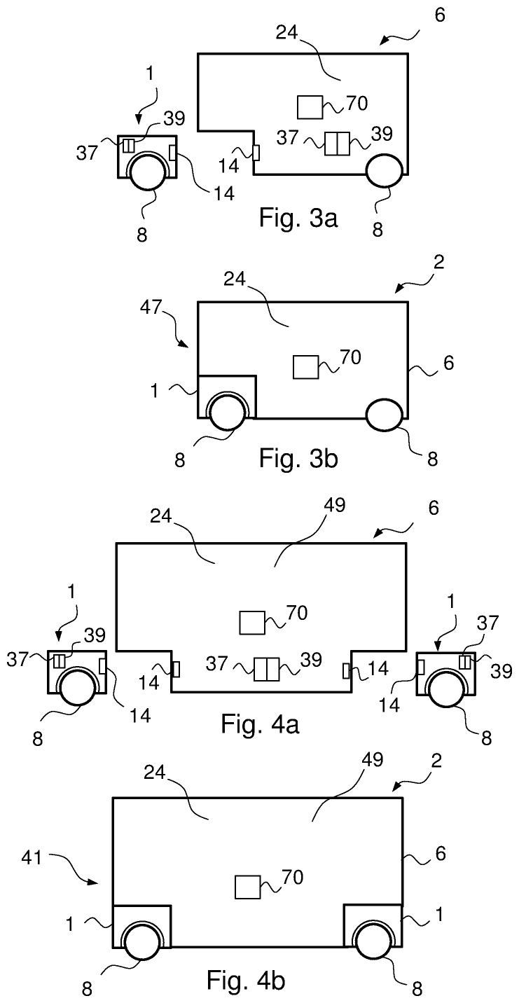

The drive module 1 may be configured to constitute a part of an assembled vehicle 2. Such a vehicle 2 assembled from a set of modules 1, 6, will be described in relation to FIGS. 3a-6b. The assembled vehicle 2 may comprise at least one functional module 6. The assembled vehicle 2 may further comprise at least one drive module 1 as disclosed in FIGS. 1a-c and FIG. 2. The assembled vehicle 2 may comprise two drive modules 1. The drive module 1 may be adapted to be configured based on a function to be performed by the drive module 1 itself or as an assembled vehicle 2. However, the drive module 1 may itself thus constitute a vehicle.

The drive module 1 may be adapted to be releasably connected to either a second drive module 1 and/or a functional module 6 for forming an assembled vehicle 2. At least one of the sides of the drive module 1 may thus have a shape that allows the drive module 1 to be releasably connected to the second drive module 1 and/or the functional module 6.

The at least two interfaces 14 may be physical interfaces 14, arranged to physically connect the drive module 1 with the second drive module 1 and/or the functional module 6.

The drive module 1 may comprise at least two interfaces 14, each arranged on different sides of the drive module 1. The interfaces 14 of the drive module 1 may be releasably connectable to a corresponding interface 14 of the second drive module 1 and/or the functional module 6. Thus, each module in the set of modules 1, 6 may comprise at least one interface 14, which may be releasably connectable to a corresponding interface 14 on another module.

The at least two interfaces 14 may be electric interfaces 14, arranged for transferring electric power and/or transmitting electric signals between the drive module 1 and the second drive module 1. The electrical interface 14 may be a wireless interface 14 or a conductive interface 14. By connecting the drive module 1 and the functional module 6 electrically, the modules 1, 6 may transfer power between each other and also share information. The drive module 1 may, for example, control parts of the functional module 6, such as opening and closing of doors, heating and cooling.

The drive module 1 may be configured to communicate with the second drive module 1 and/or the functional module 6 connected to the drive module 1. This communication may be performed by means of the interface 14. The communication between the modules 1, 6 may be wireless or conductively by wire. In case of a wireless communication between the control devices 16, 70 of the modules 1, 6, each module 1, 6 may comprise a transmitter 37 and a receiver 39 for the wireless communication. In case of a conductive communication between the control devices 16, 70 of the modules 1, 6 by wire, the functional module 6 may include a wire, which connects the interfaces 14 of the functional module 6. When the two drive modules 1 are connected to the interfaces 14 of the functional module 6, the control devices 16 of the drive modules 1 may communicate with each other and with the control device 70 of the functional module 6 via the wire in the functional module 6.

The drive module 1 may comprise at least one sensor 45 for detecting and registering objects in the surrounding of the drive module 1. The at least one sensor 45 may be a proximity sensor for detecting and registering the distance to objects, such as vehicles, pedestrians, traffic lights and/or buildings. Based on information from the at least one sensor 45, the drive module 1 may be operated such that a safe distance to the surrounding objects is maintained and accidents are avoided.

FIG. 3a schematically illustrates a side view of a drive module 1 and a functional module 6 according to an embodiment and FIG. 3b schematically illustrates a side view of an assembled vehicle 2 according to an embodiment. The drive module 1 may be configured as disclosed in FIGS. 1a-c and FIG. 2. The functional module 6 may be provided with wheels 8, but generally a functional module 6 cannot move on its own. Instead, the functional module 6 needs to be connected to at least one drive module 1 to be able to move. The functional module 6 may comprise a space 24 for accommodating or supporting a load. The at least one functional module 6 may be configured for transporting goods and may thus function as a truck 47 when being assembled with at least one drive module 1. In FIG. 3a the drive module 1 and the functional module 6 are separated. In FIG. 3b the drive module 1 has been moved in direction of the functional module 6 and the interfaces 14 of the drive module 1 and the functional module 6 have reached each other, so that the drive module 1 has been connected with the functional module 6. The functional module 6 may comprise a control device, which hereinafter will be referred to as a second control device 70. The second control device 70 of the functional module 6 may be configured to communicate with the off-board system 20 mentioned with regard to FIG. 2. The second control device 70 may also be configured to communicate with the control device 16 of the drive module 1.

FIG. 4a schematically illustrates a side view of two drive modules 1 and a functional module 6 according to an embodiment and FIG. 4b schematically illustrates a side view of an assembled vehicle 2 according to an embodiment. The at least one functional module 6 may be configured with a passenger compartment 49 for accommodating passengers and may thus function as a bus 41 when being assembled with the drive modules 1. It is to be understood that the shape of the two drive modules 1 may be identical and are configured as the drive module 1 as disclosed in FIGS. 1a-c and FIG. 2. In FIG. 4a the drive modules 1 and the functional module 6 are separated. In FIG. 4b the drive modules 1 have been moved in the direction of the functional module 6 and the interfaces 14 of the drive modules 1 and the functional module 6 have reached each other, which has resulted in the drive modules 1 being connected with the functional module 6. The second control device 70 of the functional module 6 may be configured to communicate with the off-board system 20 mentioned with regard to FIG. 2. The second control device 70 may also be configured to communicate with the control device 16 of the drive module 1.

By selecting the at least one functional module 6 and two drive modules 1 based on a function to be performed, a customized vehicle 2 can be assembled, which may be suitable for a function to be performed. Also, an assembled vehicle 2 may be achieved, which is adapted to the surroundings and the operating conditions of the vehicle 2. The off-board system 20 may for example determine that certain suspension characteristics, certain brake settings and/or a certain steering ratio are required for the function to be performed by the assembled vehicle 2. Different configurations of the drive module 1 may thus be required when the drive modules 1 form part of the assembled vehicle 2 performing the function of transporting people, transporting goods, shovelling snow etc. The drive modules 1 may also be adapted to be dynamically configured based on the surroundings in which the assembled vehicle 2 will perform its function. The configuration instructions from the off-board system 20 may thus be based on the selected functional module 6 connected with the drive module 1. The configuration of the drive module 1 is described in more detail above.

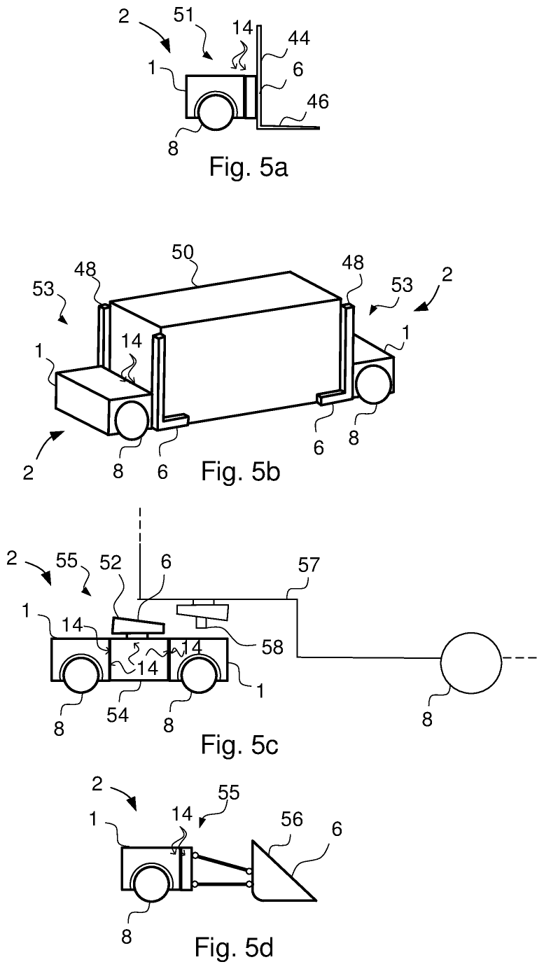

FIGS. 5a-5d schematically illustrates assembled vehicles 2 with different functional modules 6 according to different embodiments. All vehicles 2 comprises at least one drive module 1 as disclosed in FIGS. 1a-c and FIG. 2. The functional module 6 in all these embodiments may comprise a second control device, which for clarity is not shown. The second control device of the functional module 6 may be configured to communicate with the off-board system 20 mentioned with regard to FIG. 2. The second control device may also be configured to communicate with the control device 16 of the drive module 1.

The functional module 6 may be a fork lift apparatus 44 as illustrated in FIG. 5a. The fork lift apparatus 44 is connected with a drive module 1. The fork lift apparatus 44 is provided with forks 46 for lifting and moving pallets (not disclosed). Together, the fork lift apparatus 44 and the drive module 1 form a fork lift 51. The fork lift apparatus 44 is provided with an interface 14. The interface 14 may be physical and/or electrical. The interface 14 of the fork lift apparatus 44 may be connected to one of the interfaces 14 of the drive module 1. The drive module 1 communicates with the fork lift apparatus 44 via the interface 14. Thus, the fork lift apparatus 44 is adapted to receive signals from the drive module 1 to lift or lower the forks 46 of the fork lift apparatus 44.

FIG. 5b schematically illustrates an assembled vehicle 2 with a functional module 6, which is a container lift 48. The container lift 48 is connected with a drive module 1 and together form a container lift vehicle 53. The container lift 48 is arranged for lifting and moving containers 50. The container lift 48 is provided with an interface 14. The interface 14 may be physical and/or electrical. The interface 14 of the container lift 48 may be connected to one of the interfaces 14 of the drive module 1. The drive module 1 communicates with, and/or controls, the container lift 48 via the interface 14. Thus, the container lift 48 is adapted to receive signals from the drive module 1 to operate the container lift 48. A container 50 may be lifted and moved by two container lift vehicles 53 each provided with a container lift 48. The drive modules 1, 4 with container lifts 48 may grip the container 50 from opposite sides of the container 50. The container 50 may be lifted simultaneously by the container lifts 48, which are arranged on the drive modules 1. Thereafter the container lift vehicles 53 may together move the container 50.

FIG. 5c schematically illustrates an assembled vehicle 2 with a functional module 6, which is a turntable 52. The turntable 52 is arranged on a drive module 1. The turntable 52 and the drive module 1 together form a tractor vehicle 55 for transporting trailers 57. The turntable 52 is arranged for connecting a trailer 57 to the drive module 1. The turntable 52 is provided with an interface 14. The interface 14 may be physical and/or electrical. The interface 14 of the turntable 52 may be connected to one of the interfaces 14 of the drive module 1. The drive module 1 communicates with the turntable 52 via the interface 14. The drive module 1 may control the turntable 52 to lock and release a kingpin 58 arranged on the trailer 57. The turntable 52 may be arranged on a distance element 54 arranged between two drive modules 1. The distance element 54 may be provided with at least two interfaces 14. One of the interfaces 14 is connected with the interface 14 of at least one of the drive modules 1 and the other interface 14 is connected with the interface 14 of the turntable 52. With such a distance element 54 arranged between two drive modules 1, at least one of the drive modules 1 may communicate with the turntable 52 through the interfaces 14 of one of the drive modules 1, of the distance element 54 end of the turntable 52.

FIG. 5d schematically illustrates an assembled vehicle 2 with a functional module 6, which is a bucket 56. The bucket 56 is connected with a drive module 1. The bucket 56 and the drive module 1 together form an excavator 60. The bucket 56 may be arranged for excavating soil, snow or similar. The bucket 56 is provided with an interface 14. The interface 14 may be physical and/or electrical. The interface 14 of the bucket 56 may be connected with one of the interfaces 14 of the drive module 1. The drive module 1 communicates with the bucket 56 via the interface 14. The drive module 1 may control the bucket 56 to excavate soil, snow or similar.

The foregoing description of the embodiments has been furnished for illustrative and descriptive purposes. It is not intended to be exhaustive, or to limit the embodiments to the variants described. Many modifications and variations will obviously be apparent to one skilled in the art. The embodiments have been chosen and described in order to best explicate principles and practical applications, and to thereby enable one skilled in the art to understand the embodiments in terms of its various embodiments and with the various modifications that are applicable to its intended use. The components and features specified above may, within the framework of the embodiments, be combined between different embodiments specified.

1. A functional module configured for accommodating or supporting a load and at least one drive module capable of driving the functional module to operate, wherein the functional module is adapted to be releasably connected to the at least one drive module for forming an assembled vehicle;
the drive module comprising:
at least a pair of wheels;
at least one propulsion unit connected to the wheels;
at least one energy storage unit for providing the propulsion unit with energy;
a control device configured and operable to operate the drive module as an independent drive unit; and
at least two first interfaces on the drive module, each first interface configured for releasable connection with a respective second interface of at least one of the functional modules, each of the first interfaces being arranged on a respective different side of the drive module; and
the drive module is configured to be autonomously operated;
the functional module comprising:
at least one of the second interfaces configured for releasable connection with a first interface of the drive module; and
a second control device configured to communicate with an off-board system.

2. The functional module according to claim 1, wherein the second control device of the functional module is configured to communicate with the control device of the drive module.

3. The functional module according to claim 1, wherein the functional module includes an energy storage unit.

4. The functional module according to claim 1, wherein the functional module is adapted to receive instructions to connect with a drive module.

5. The functional module according to claim 1, wherein the second control device is configured to transmit at least one configuration for the drive module to the control device of a drive module, wherein the at least one configuration is stored in the second control device of the functional module and is based on a function to be performed by an assembled vehicle.

6. The functional module according to claim 1, wherein the functional module comprises a display showing a registration number.

7. The functional module according to claim 1, wherein each of the interfaces is a physical interface arranged to physically connect the functional module with the drive module and/or is an electrical interface arranged for transferring electric energy and/or transmitting electric signals between the functional module and the drive module.

8. The functional module according to claim 1, wherein the functional module is a fork lift apparatus.

9. The functional module according to claim 1, wherein the functional module is configured for transporting goods.

10. The functional module according to claim 1, wherein the functional module is configured with a passenger compartment.

11. The functional module according to claim 1, wherein the functional module is a container lift.

12. The functional module according to claim 1, wherein the functional module is a turntable, which is connectable to a trailer.

13. The functional module according to claim 1, wherein the functional module is a bucket.

14. A vehicle assembled from a set of modules, the vehicle comprising:
at least one drive module comprising:
at least a pair of wheels;
at least one propulsion unit connected to the wheels;
at least one energy storage unit for providing the propulsion unit with energy;
a control device configured to operate the drive module as an independently driven unit; and
at least two first interfaces on the drive module, each first interface being configured for releasable connection with a respective second interface of at least one functional module, each first interface being arranged on a respective different side of the drive module;
wherein the drive module is configured to be autonomously operated; and
wherein the vehicle further comprises at least one functional module according to claim 1.

15. The vehicle according to claim 14, wherein the vehicle comprises two drive modules.

16. The vehicle according to claim 15, wherein one of the drive modules is configured to operate as a master and the other drive module and the functional module is configured to operate as a slave.
